(19) United States
(12) Patent Application Publication
(10) Pub. No.: US 2026/0069377 A1
(43) Pub. Date: Mar. 12, 2026

(54) DENTAL INSTRUMENT, IMPACTED TOOTH TRACTION DEVICE AND THE INSTALLATION METHOD THEREOF

(71) Applicant: LIANG-CHENG CHEN, Taichung City (TW)

(72) Inventor: LIANG-CHENG CHEN, Taichung City (TW)

(21) Appl. No.: 19/394,187

(22) Filed: Nov. 19, 2025

Related U.S. Application Data
(62) Division of application No. 18/408,059, filed on Jan. 9, 2024.

(30) Foreign Application Priority Data
Aug. 25, 2023 (TW) 112132209

(51) Int. Cl. A61C 3/14

(52) U.S. Cl. CPC A61C 3/14

(57) ABSTRACT

A dental instrument includes a handle and an extension portion, the extension portion has a frontal protrusion that is used to hang an elastic traction ligature. An impacted tooth traction device includes a first bracket for being fastened to an impacted tooth, and a second bracket for being fastened to an anchor body, and the aforementioned elastic traction ligature that is used to connect the first bracket with the second bracket. A method for installing the impacted tooth traction device includes: fastening the first bracket to the impacted tooth, fastening the second bracket to the anchor body, and to connect the elastic traction ligature to the first and the second brackets after the elastic traction ligature is pulled to a certain length.

### CROSS-REFERENCE TO RELATED APPLICATION

This application is a Divisional of co-pending Application No. Ser. No. 18/408,059, filed on Jan. 9, 2024, and for which priority is claimed under 35 U.S. C. § 120; and this application claims priority of Application No. 112132209 filed in Taiwan on Aug. 25, 2023 under 35 U.S. C. § 119, the entire contents of all of which are hereby incorporated by reference.

### FIELD OF THE INVENTION

This invention relates to dental equipment, particularly to a dental instrument, impacted tooth traction device, and the method of its installation.

### DESCRIPTION OF THE PRIOR ART

Impacted teeth can be simply understood as teeth that are trapped and cannot erupt normally. This can include misaligned teeth, teeth obstructed by other teeth, abnormally shaped teeth that cannot emerge, supernumerary teeth, or teeth covered by gums or bone, limiting the space for full eruption. For instance, lower wisdom teeth are among the most common impacted teeth, often growing horizontally within the gums and being in close proximity to the inferior alveolar nerve. In the past, impacted teeth were typically removed through oral surgery, a method that frequently caused discomfort and pain to patients. Additionally, the direct removal of impacted teeth resulted in large post-extraction sockets, immediately compromising the adjacent teeth's support and creating a conducive environment for bacterial growth. Moreover, during the direct extraction of impacted teeth, there was a risk of nerve damage due to certain pulling motions.

### SUMMARY OF THE INVENTION

The present invention provides a dental instrument comprising a handle, an extension connected to the front end of the handle, and a front protrusion mounted on the extension. The front protrusion is used to pass through a hole in an elastic traction ligature.

In one embodiment, the dental instrument of the present invention comprises an extension, which includes a straight portion and a bent portion. The straight portion is connected to the front end of the handle and extends in the same direction as the handle, while the bent portion is connected to the straight portion at an angle of more than 90 degrees.

In one embodiment, the front protrusion of the dental instrument of the present invention is mounted on the bent portion.

In one embodiment, the dental instrument of the present invention additionally features a back protrusion located on the straight portion, which is used to pass through another hole in the elastic traction ligature.

In one embodiment, the angle between the bent portion and the straight portion of the dental instrument of the present invention is 120 degrees.

In one embodiment, the width of the straight portion of the dental instrument of the present invention gradually increases in a direction away from the handle.

In one embodiment, the front protrusion of the dental instrument of the present invention includes a pole and an enlarged cap with an outer diameter larger than the pole. The pole is connected at both ends to the extension and the enlarged cap.

In one embodiment, the enlarged cap of the dental instrument of the present invention features a front eave located in front of the pole and a rear eave located behind the pole with the length of the front eave being smaller than that of the rear eave.

In one embodiment, the front edge of the bent portion of the dental instrument of the present invention has a recess that is used to accommodate a wire and restrict the movement of the wire.

In one embodiment, the recess of the dental instrument of the present invention includes a shallow portion adjacent to the front edge and a deep portion away from the front edge, where the width of the shallow portion is greater than the width of the deep portion.

In one embodiment, the dental instrument of the present invention is further equipped with a back protrusion located on the extension, and the front and back protrusions are separated by a distance. The back protrusion is positioned closer to the front end of the handle and is used to pass through another hole in the elastic traction ligature.

Furthermore, the present invention provides an impacted tooth traction device comprising a first bracket for securing to an impacted tooth, a second bracket for securing to an anchor body at a distance from the impacted tooth, and an elastic traction ligature for connecting the first bracket to the second bracket.

In one embodiment, the elastic traction ligature of the impacted tooth traction device comprises an elastic strap and at least two holes formed in the elastic strap, with the two holes arranged along the length direction of the elastic strap. One of the holes is used to accommodate the first bracket, and the other hole is used to accommodate the second bracket.

In one embodiment, the first bracket of the impacted tooth traction device is formed by a wire, the wire includes a twisted portion and a ring portion that is used to pass through a through hole in the impacted tooth and the other hole in the elastic traction ligature.

In one embodiment, the first bracket of the impacted tooth traction device is formed by a wire, the wire includes a twisted portion and a ring portion that is used to pass through a through hole in the impacted tooth. The twisted portion is bent to form a hook portion that hooks into the other hole in the elastic traction ligature.

The present invention further provides an installation method for an impacted tooth traction device, including:
step a: fixing a first bracket to an impacted tooth; and
step b: connecting an elastic traction ligature to the first bracket and a second bracket that is fixed on an anchor body.

In one embodiment, the first bracket is formed by a wire, and the step a includes threading the wire through a through hole in the impacted tooth, bringing the ends of the wire close to each other, fitting one hole of the elastic traction ligature onto the wire on the impacted tooth, and then twisting the wire to form a twisted portion and a ring portion connected to the twisted portion, wherein the ring portion is passed through the through hole and a hole of the elastic traction ligature.

In one embodiment, the step b comprises stretching the elastic traction ligature, and connecting the stretched elastic traction ligature to the second bracket.

In one embodiment, the step a includes threading the wire through a through hole in the impacted tooth, bringing the ends of the wire close to each other, twisting the wire to form a twisted portion and a ring portion connected to the twisted portion; and then bending the twisted portion to form a hook portion.

In one embodiment, the step b comprises fitting a hole of the elastic traction strap onto the hook portion of the wire on the impacted tooth, stretching the elastic traction ligature, and then connecting the stretched elastic traction ligature to the second bracket.

### BRIEF DESCRIPTION OF THE DRAWINGS

FIG. 1 is a perspective view of an embodiment of the dental instrument of the present invention.

FIG. 2 is a side view of the extension of the dental instrument of the present invention.

FIG. 3 is a plan view of the extension portion of the dental instrument of the present invention.

FIG. 4 is a plan view of the front protrusion of the dental instrument of the present invention.

FIG. 5 is a partial perspective view of another embodiment of the dental instrument of the present invention.

FIG. 6 illustrates a perspective view of a wire passing through an impacted tooth.

FIG. 7 is a partial perspective view of the dental instrument of the present invention mounting an elastic traction ligature.

FIGS. 8 to 11 schematically illustrate the process of the dental instrument of the present invention assisting in the installation of the first bracket and the elastic traction ligature.

FIGS. 12 and 13 are plan views of an impacted tooth traction device of the present invention in different states.

FIGS. 14 and 15 are plan views of other embodiments of the impacted tooth traction device of the present invention.

### DETAILED DESCRIPTION OF EMBODIMENTS

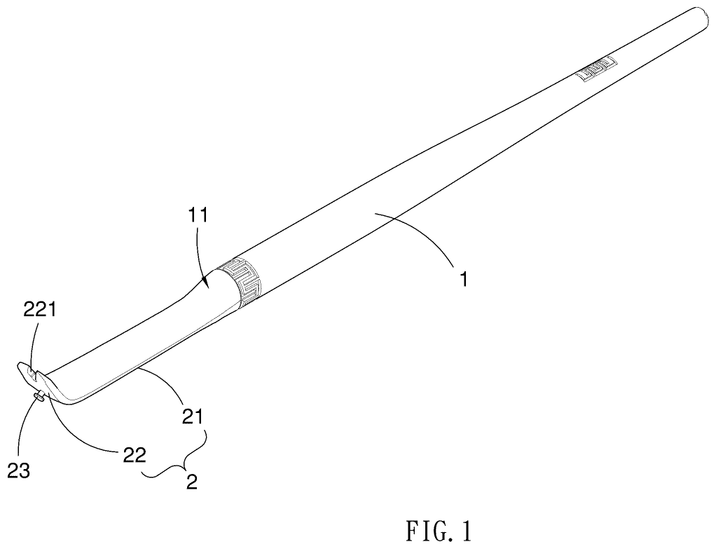

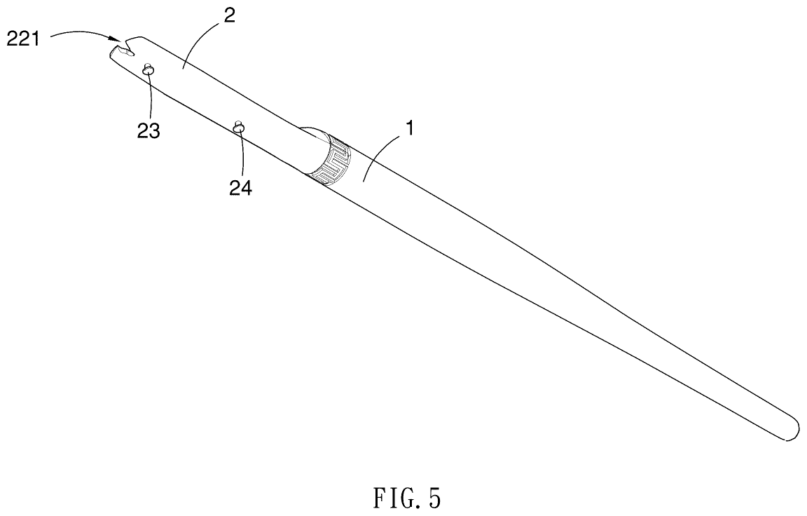

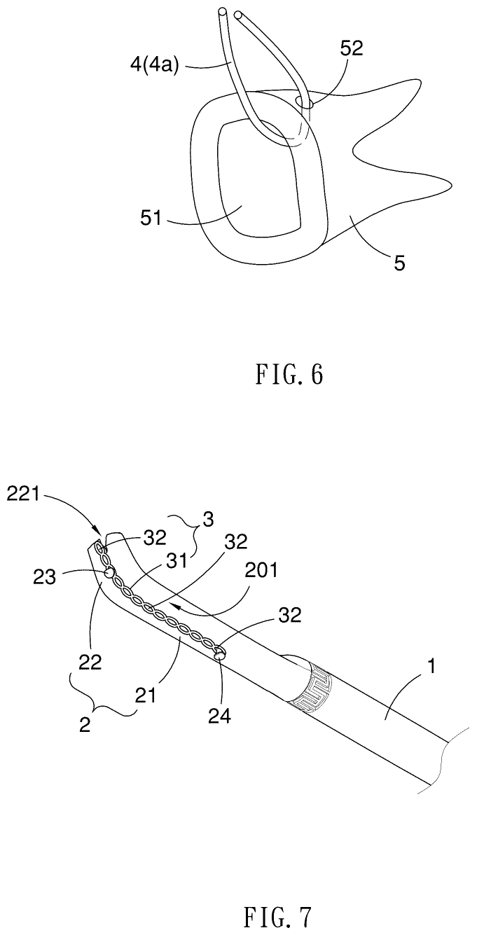

FIGS. 1 to 4 illustrate an embodiment of the dental instrument of the present invention, which assists in the installation process of the impacted tooth traction device of the present invention. FIG. 5 illustrates another embodiment of the dental instrument. FIGS. 6 to 15 illustrate an embodiment of the impacted tooth traction device of the present invention and its installation method.

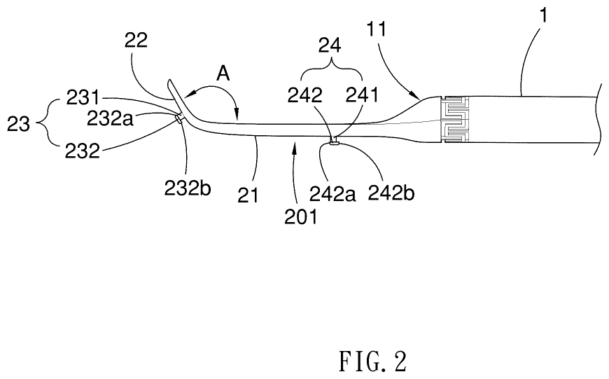

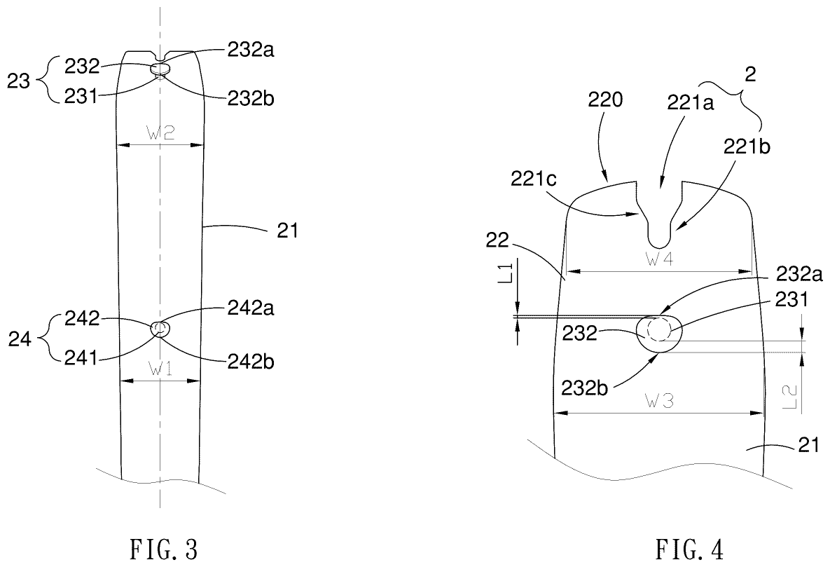

As shown in FIG. 1, the dental instrument comprises a handle 1 suitable for user grip and an extension 2 connected to the front portion 11 of the handle 1. The extension 2 includes a straight portion 21 adjacent to the handle 1 and a bent portion 22 away from the handle 1. As shown in FIG. 2, the straight portion 21 extends in the same direction as the handle 1, and both the straight portion 21 and the bent portion 22 are flat, with an angle A between them being 90 degrees or more. In this embodiment, angle A is 120 degrees. Furthermore, as shown in FIG. 3, the width of the straight portion 21 is preferably gradually increasing in a direction away from the handle 1, so a first width W1 is smaller than a second width W2. As shown in FIG. 4, the width of the bent portion 22 is gradually decreasing in a direction away from the straight portion 21, so a third width W3 is larger than a fourth width W4.

As shown in FIGS. 1 and 2, the extension 2 has a front protrusion 23. In this embodiment, an additional back protrusion 24 can also be mounted on the extension 2, but this is not necessary. Both the front and back protrusions 23 and 24 are located on the back surface 201 of the extension 2. The back protrusion 24 is closer to the front portion 11 of the handle 1 than the front protrusion 23, as shown in FIG. 3. The front and back protrusions 23 and 24 are spaced apart and aligned on a longitudinal axis B. Preferably, the front protrusion 23 is located on the bent portion 22, and the back protrusion is located on the straight portion 21.

As shown in FIGS. 2 and 4, the front protrusion 23 comprises a pole 231 and an enlarged cap 232 with a diameter larger than the pole 231. One end of the pole 231 is connected to the enlarged cap 232, and the other end is connected to the extension 2. The enlarged cap 232 has a front eave 232a located in front of the pole 231 and a rear eave 232b located behind the pole 231. The length L1 of the front eave 232a is smaller than the length L2 of the rear eave 232b. The front edge of the front eave 232a is flat, while the rear edge of the rear eave 232b is curved. As shown in FIGS. 2 and 3, the back protrusion 24 is the same as the front protrusion 23, meaning a pole 241, an enlarged cap 242, a front eave 242a, and a rear eave 242b of the back protrusion 24 are all the same as the corresponding parts of the front protrusion 23, without repeating further.

As depicted in FIGS. 1 and 4, the front edge 220 of the bent portion 22 has a recess 221. The recess 221 comprises a shallow portion 221a and a deep portion 221b that is wider than the shallow portion 221a. The shallow portion 221a is adjacent to the front edge 220. The central position of the deep portion 221b is open to the shallow portion 221a. The width of the shallow portion 221a gradually diminishes towards the deep portion 221b, or in other words, a funnel-shaped tapered portion 221c is formed between the shallow portion 221a and the deep portion 221b. The width of the tapered portion 221c progressively narrows from the shallow portion 221a towards the deep portion 221b.

FIG. 5 shows another embodiment of the dental instrument of the present invention. It is generally similar to the embodiment described above, with the main difference being that its extension 2 is entirely straight and lacks any bends. Therefore, its recess 221 is located on the front edge of the extension 2. As for the front protrusion 23 and back protrusion 24, they are the same as described above, without going into further detail.

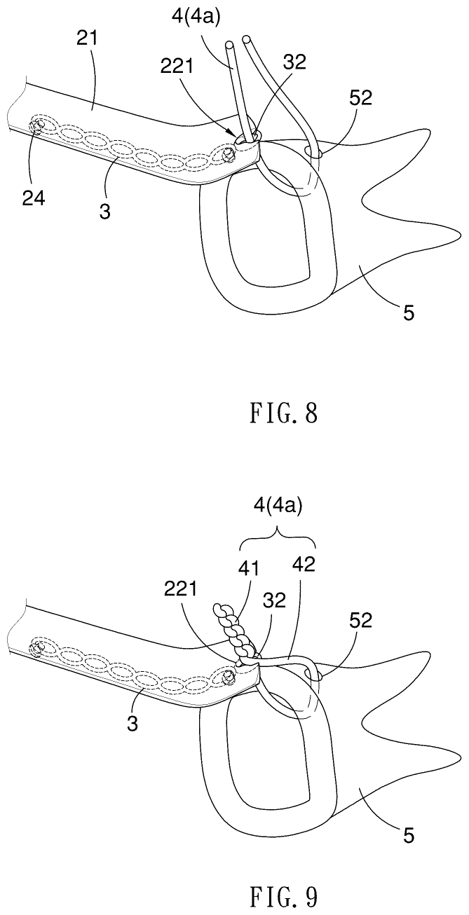

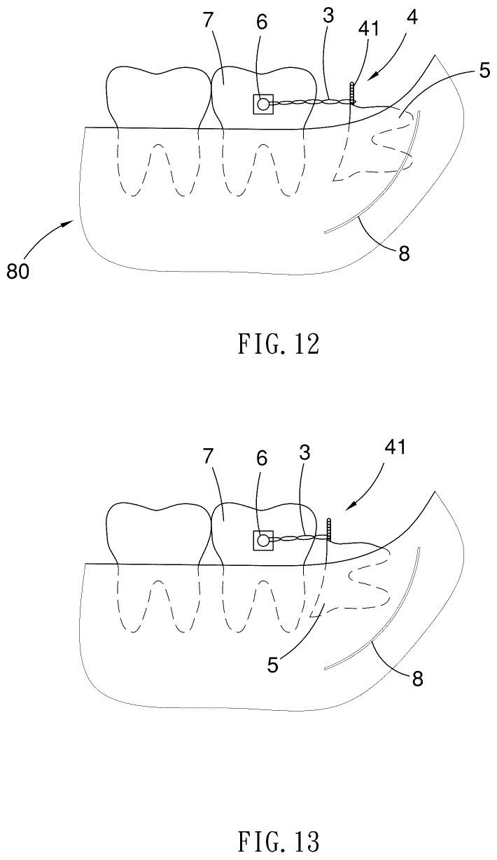

FIG. 6 illustrates a case where a portion of the crown of an impacted tooth 5 has been removed, leaving only the lower part. The pulp cavity of this lower part has been prepared and enlarged into a slot 51. Additionally, a through hole 52, interconnected to the slot 51, has been drilled in this lower part. In this embodiment, the impacted tooth 5 originally grew horizontally inside the gum, and it was surgically treated to achieve the state shown in FIG. 6. FIG. 6 omits the gum and only shows the impacted tooth 5, as do FIGS. 8 to 11. FIGS. 12 to 15 schematically depict the gum 80, with the formed flap created after cutting open the gum 80 omitted.

FIG. 12 illustrates an embodiment of the tooth impaction traction device of the present invention, which includes a first bracket 4 configured for attachment to an impacted tooth (such as the impacted tooth 5 shown in FIG. 6), a second bracket 6 configured for attachment to an anchor body 7, and an elastic traction ligature 3 configured for connecting the first bracket 4 to the second bracket 6. The elastic traction ligature 3, which has connected the first bracket 4 and the second bracket 6, is stretched to a length, resulting in a resilient restoring force. Due to the restoring force generated by the elastic traction ligature 3, the impacted tooth 5 continuously experiences tension in the direction towards the anchor body 7, gradually moving in that direction. After a period of time, the impacted tooth 5 is positioned as desired, as shown in FIG. 13. At this point, a portion or all of the tooth impaction traction device of the present invention can be disassembled, and the impacted tooth 5 can then be surgically removed

An embodiment of the installation method for the tooth impaction traction device of the present invention includes the following steps a to c:
Step a: Securing the first bracket 4 to the impacted tooth 5 and connecting the elastic traction ligature 3 to the first bracket 4;
Step b: Securing the second bracket 6 to the anchor body 7; and
Step c: Stretching the elastic traction ligature 3 to a certain length before connecting it to the second bracket 6.

The above steps a and b are not limited in order of execution; in other words, it is possible to choose which step to execute first according to the requirements.

In this embodiment, the first bracket 4 is composed of a wire 4a. The wire 4a is typically made of metal, such a steel wire, but not limited thereto.

In this embodiment, as shown in FIG. 7, the elastic traction ligature 3 comprises an elongated elastic strap 31 and multiple holes 32 formed on the elastic strap 31 and arranged along the length direction of the elastic strap 31.

In this embodiment, as shown in FIG. 12, the anchor body 7 is a normal tooth near the impacted tooth 5, but it can also be a bone screw anchored in the bone (not shown in the figure).

In this embodiment, the fastener 6 is a column attached to the normal tooth, but not limited thereto.

When the first bracket 4 is composed of wire 4a, step a is accomplished through the following sub-steps:
Step a1: Thread the wire 4a through a through hole 52 of the impacted tooth 5 and bring the ends of the wire 4a close to each other, as shown in FIG. 6;
Step a2: Slip one of the holes 32 of the elastic traction ligature 3 over the wire 4a located on the impacted tooth 5, as shown in FIG. 8; and
Step a3: Twist the wire 4a to form a twisted portion 41 and a ring portion 42 connected to the twisted portion 41, as shown in FIG. 9. The ring portion 42 passes through the through hole 52 and the hole 32 of the elastic traction ligature 3, encircling the impacted tooth 5.

Through the above steps a1 to a3, the operation of fixing the first bracket 4 to the impacted tooth 5 and the operation of connecting the elastic traction ligature 3 can be completed simultaneously.

Another embodiment of the installation method for the impacted tooth traction device of the present invention includes the following steps d to f:
Step d: Fixing the first bracket 4 to the impacted tooth 5;
Step e: Fixing the second bracket 6 to the anchor body 7; and
Step f: Stretching the elastic traction ligature 3 to a length, and then connecting it to the first bracket 4 and the second bracket 6.

There are no specific requirements regarding the order of steps d and f; that is, you can choose which step to perform first as needed.

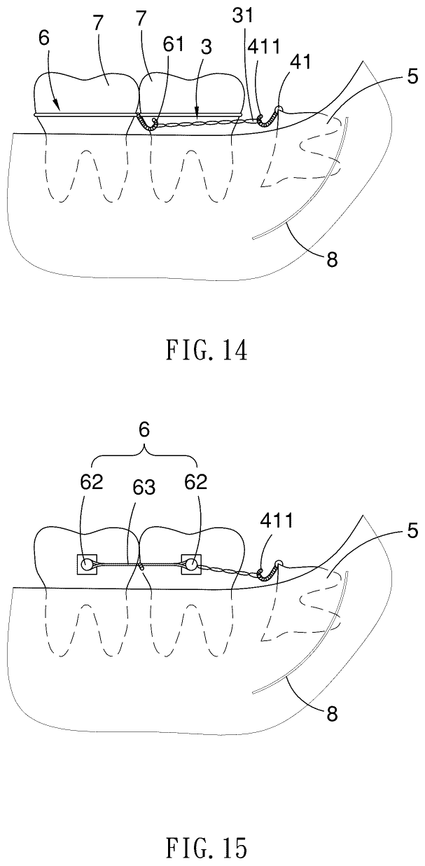

When the first bracket 4 is composed of the wire 4a, step d is completed through the following sub-steps:
Step d1: Thread the wire 4a through the through hole 52 of the impacted tooth 5 and bring the ends of the wire 4a close to each other, as shown in FIG. 6.
Step d2: Twist the wire 4a to form the twisted portion 41 and the ring portion 42 connected to the twisted portion 41, as shown in FIG. 9. The ring portion 42 passes through the through hole 52 and encircles the impacted tooth 5.
Step d3: Bend the twisted portion 41 to form a hook portion 411, as shown in FIG. 14.

Thus, in step f, the hook portion 411 can be used to hook into the hole 32 on the elastic traction ligature 3, while another hole 32 on the elastic traction ligature 3 is hooked by a hook portion 61 on the second bracket 6. The second bracket 6 is made of a wire that is bound to the anchor body 7 (i.e., two normal teeth) to form a fixation. After binding the wire (namely, the second bracket 6), it is bent to form the hook portion 61 mentioned above. As shown in FIG. 14, the stretched elastic traction ligature 3 is hooked by the hook portion 411 of the first bracket 4 and the hook portion 61 of the second bracket 6 at both ends. In contrast, in FIG. 12, one end of the stretched elastic traction ligature 3 is tied with the ring portion 42 of the first bracket, while the other end is threaded through the hole 32 and fitted onto the second bracket 6, where the second bracket 6 is a column adhered to the anchor body 7 (a normal tooth).

Additionally, FIG. 15 shows another embodiment of the second bracket 6 that includes two columns 62 and a metal wire 63 binding them together. Both columns 62 are adhered to two normal teeth, and are connected together by the metal wire. The two ends of the wire 3 are respectively connected to one of the columns 62 and the hook portions 411.

In summary, the holes 32 of the elastic traction ligature 3 are either passed through by the above-mentioned columns 62 or hooked by the above-mentioned hook portions 411, 61. However, these are just one of the ways to connect the elastic traction ligature 3 with the first bracket 4 or the second bracket 6 and are not limited to this.

Furthermore, as is generally known, the above-mentioned columns 62 typically have larger heads to prevent the holes 32 of the elastic traction ligature 3 from slipping off from the columns 62.

In the above steps, the dental instrument of the present invention can be used to mount the elastic traction ligature 3 and quickly install it on the wire 4a, but not limited to this. In other words, other tools can also be used to assist in installing the elastic traction ligature 3 on the wire 4a.

The method of using the dental instrument of the present invention is as follows: as shown in FIG. 7, a dentist can first thread the front protrusion 23 of the dental instrument into one of the holes 32 on the elastic traction ligature 3. Then, the dentist stretches the elastic strap 31 of the elastic traction ligature 3 to create a length, allowing the elastic traction ligature 3 to accumulate elasticity for restoring to its original length. Next, the dentist threads the back protrusion 24 of the dental instrument into another hole 32 on the elastic traction ligature 3. At this point, the dentist has completed the operation of attaching the elastic traction ligature 3 to the dental instrument. Currently, the elastic traction ligature 3 has two holes 32 fitted onto the front protrusion 23 and the back protrusion 24, and one hole 32 is exposed within the recess 221 on the bent portion 22.

The elastic strap 31 of the elastic traction ligature 3 forms a moderate elastic stretch between the front protrusion 23 and the back protrusion 24. Therefore, the elastic traction ligature 3 can be securely mounted on the back surface 201 of the extension 2 without arbitrary movement. As the dental instrument is manipulated by the dentist during the procedure, the elastic traction ligature 3 remains stably adhered to the extension 2, without any relative drifting or swinging. Consequently, the dentist can quickly thread the hole 32 of the elastic traction ligature 3 onto the wire 4a located on the impacted tooth 5, as shown in FIG. 8, within the constraints of a narrow oral cavity. Furthermore, in cases where there is an enlarged cap 232, the enlarged cap 232 can be employed to constrain the elastic traction ligature 3, preventing it from disengaging from the front protrusion 23 and the back protrusion 24.

In steps a3 and d2 mentioned above, the dentist can use a tool (not shown in the figures) to twist roughly the U-shaped wire 4a, creating the twisted portion 41 and the ring portion 42. While twisting the wire 4a, the dentist can utilize the recess 221 to accommodate the wire 4a, limiting its movement, ensuring that the wire 4a does not shift or rotate arbitrarily during the twisting process.

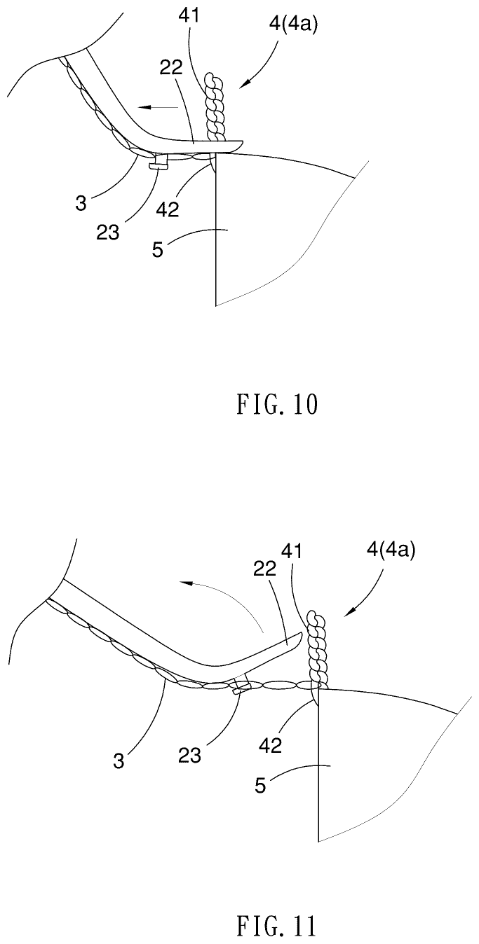

Upon completing the aforementioned procedures, the dentist can simply pull back and slightly tilt the bent portion 22 upward, as shown in FIGS. 10 and 11. This action allows the front protrusion 23 to disengage from the hole 32 of the elastic traction ligature 3. The size and shape configuration of the front eaves 232a and rear eaves 232b of the enlarged cap 232 mentioned above, aids in the smooth disengagement of the front protrusion 23 from the hole 32 and facilitates its insertion into the hole 32. An enlarged cap of the rear protrusion 24 serves a similar purpose and requires no further elaboration.

After the elastic traction ligature 3 has disengaged from the front protrusion 23 and back protrusion 24, the dentist proceeds to stretch the elastic traction ligature 3 to create a length, allowing the elastic traction ligature 3 to accumulate elasticity for restoring to its original length. Subsequently, one of the holes 32 of the elastic traction ligature 3 is fitted onto the second bracket 6 as shown in FIG. 12, or onto the hook 61 as shown in FIG. 14, or onto the anchor 62 as shown in FIG. 15. At this point, the installation of the impacted tooth traction device of the present invention is completed. The second bracket 6 shown in FIG. 12 is an anchor, same as FIG. 13, they are the same as the anchors 62 shown in FIG. 15.

As shown in FIGS. 12 and 13, because the elastic traction ligature 3 is connected to both the fastener 6 and the impacted tooth 5 at its ends, the accumulated elasticity in the elastic traction ligature 3 can be utilized to gradually pull or drag the impacted tooth 5 away from the nearby nerves, such as the alveolar nerve 8. After the impacted tooth 5 has been moved away from the adjacent nerves, it can be subsequently removed through dental surgery.

Compared to the conventional method of directly removing the impacted tooth 5, the approach used in this invention, which gradually moves the impacted tooth 5 away from its original position and further from the nearby nerves using the elastic traction ligature 3 before extraction, not only reduces discomfort and pain during and after the procedure but also lowers the risk of nerve damage near the impacted tooth 5. Furthermore, in the process of gradually moving the impacted tooth 5 using the elastic traction ligature 3 of this invention, the impacted tooth 5 moves in small increments. The small bone voids created with each movement are quickly filled with new bone, thereby resolving the problem of bone voids left unhealed when an impacted tooth is directly removed.

In the above embodiment, the wire 4a is twisted to form the twisted portion 41 after passing through the hole 32 of the elastic traction ligature 3. However, in some instances, the wire 4a is twisted first to form the twisted portion 41 and then the twisted portion 41 is bent to form the hook portion 411, as shown in FIG. 14.

Furthermore, as shown in FIGS. 8 to 9, the recess 221 of this dental instrument can accommodate the wire 4, allowing the wire 4 to rest against it. This helps to prevent or reduce the wire 4 from scratching the muscles on the inside of the cheek during the twisting process. Additionally, the straight portion 21 of this dental instrument can be inserted into the mouth and used to push aside and support the cheek. The junction between the straight portion 21 and the bent portion 22 can be used to block the flipped flap of tissue from returning to its original position. The bent portion 22 can also be used to restrain the elastic traction ligature 3. Therefore, the dentist can conveniently, quickly, and safely pass the wire 4 through the impacted tooth 5, mount the elastic traction ligature 3 onto the wire 4a, and twist the wire 4a. In summary, this dental instrument of the present invention assists dentists in conveniently, quickly, and safely installing the impacted tooth traction device completely.

What is claimed is

1. An impacted tooth traction device comprising:
a first bracket configured to fix to an impacted tooth, wherein a portion of the first bracket passes through a through hole in the impacted tooth;
a second bracket configured to fix to an anchor body at a distance from the impacted tooth; and
an elastic traction ligature configured to connect to the first bracket and the second bracket.

2. The impacted tooth traction device as recited in claim 1, wherein the elastic traction ligature comprises an elastic strap and at least two holes formed in the elastic strap, with the two holes arranged along the length of the elastic strap, wherein one of the holes is used to fit onto the first bracket, and the other hole is used to fit onto the second bracket.

3. The impacted tooth traction device as recited in claim 2, wherein the first bracket is formed by a wire, the wire comprising a twisted portion and a ring portion connected to the twisted portion that the ring portion passes through the through hole in the impacted tooth and through the other hole of the elastic traction ligature.

4. The impacted tooth traction device as recited in claim 2, wherein the first bracket is formed by a wire, the wire comprising a twisted portion and a ring portion connected to the twisted portion that the ring portion passes through the through hole in the impacted tooth, and the twisted portion is bent to form a hook portion, which is used to engage the other hole of the elastic traction ligature.
